(19) United States
(12) Patent Application Publication
(10) Pub. No.: US 2026/0261771 A1
(43) Pub. Date: Sep. 3, 2026

(54) Inspection Apparatus and Inspection Method

(71) Applicant: Hitachi GE Vernova Nuclear Energy, Ltd., Hitachi-shi (JP)

(72) Inventor: Takeshi SHIMANO, Tokyo (JP)

(21) Appl. No.: 19/551,783

(22) Filed: Feb. 27, 2026

(30) Foreign Application Priority Data
Mar. 3, 2025 (JP) 2025-032578

(51) Int. Cl. H04N 23/74; H04N 7/18; H04N 23/56; H04N 23/71

(52) U.S. Cl. CPC H04N 23/74; H04N 7/183; H04N 23/56; H04N 23/71

(57) ABSTRACT

An inspection apparatus includes a plurality of types of illumination that illuminate an inspection surface; a camera that captures images of the inspection surface; and an image processing unit that generates an inspection image by combining a plurality of images of the inspection surface sequentially captured by the camera as the types of illumination are sequentially turned on. The image processing unit generates the inspection image such that the standard deviation for the combined luminance of corresponding pixels among the plurality of images is minimized within a predetermined calculation range set in an image area of each of the images.

### BACKGROUND

### Technical Field

The present invention relates to an inspection apparatus and an inspection method.

### Related Art

Patent Literature 1 describes a technique for inspecting the surface condition of an object to be inspected. Patent Literature 1 states: “The visibility of cracks is improved by independently controlling the luminance of bright-field illumination and dark-field illumination. . . . That is, adjustments are made to reduce the differences in brightness between (diffusive) regions 131 and (reflective) regions 132. This produces a clearer distinction between the image of a crack 104 and images of other parts, thereby improving the visibility of the crack 104”.

### CITATION LIST

### Patent Literature

Patent Literature 1: JP 2022-1844 A

### SUMMARY

However, the technique described in Patent Literature 1 cannot sufficiently improve the visibility of cracks across the entire inspection surface when the optimal balance of luminance between the two types of illumination varies by location, such as when the illumination distribution is not uniform at each location on the inspection surface or when the surface reflectance differs from location to location.

Therefore, it is an object of the present invention to provide an inspection apparatus and an inspection method capable of improving the visibility of cracks regardless of the surface condition of the object being inspected.

A configuration described in the claims, for example, will be adopted to solve the problem described above.

The present invention includes a plurality of means for solving the above problem. To give one example, an inspection apparatus includes a plurality of types of illumination that illuminate an inspection surface; a camera that captures images of the inspection surface; and an image processing unit that generates an inspection image by combining a plurality of images of the inspection surface sequentially captured by the camera as the plurality of types of illumination are sequentially turned on. The image processing unit generates the inspection image such that the standard deviation for the combined luminance of corresponding pixels among the plurality of images is minimized within a predetermined calculation range set in an image area of each of the images.

The present invention can provide an inspection apparatus and an inspection method capable of improving the visibility of cracks regardless of the surface condition of the object being inspected.

### BRIEF DESCRIPTION OF DRAWINGS

FIG. 1 illustrates a configuration of an inspection apparatus according to an embodiment (a first view);

FIG. 2 illustrates the configuration of the inspection apparatus according to the embodiment (a second view);

FIG. 3 is a block diagram of the inspection apparatus according to the embodiment;

FIG. 4 is a flowchart illustrating an inspection method according to the embodiment;

FIG. 5 is an explanatory diagram illustrating an image processing in the inspection method according to the embodiment;

FIG. 6 illustrates each image of an inspection surface captured by an imaging device and a composite image of these images; and

FIG. 7 illustrates calculated values of the luminance standard deviation of images obtained while varying an illumination ratio.

### DETAILED DESCRIPTION

Below, an embodiment of an inspection apparatus and an inspection method of the present invention will be described in detail with reference to the drawings. In the drawings used for this embodiment, the same components are denoted by the same reference numerals.

### <<Inspection Apparatus>>

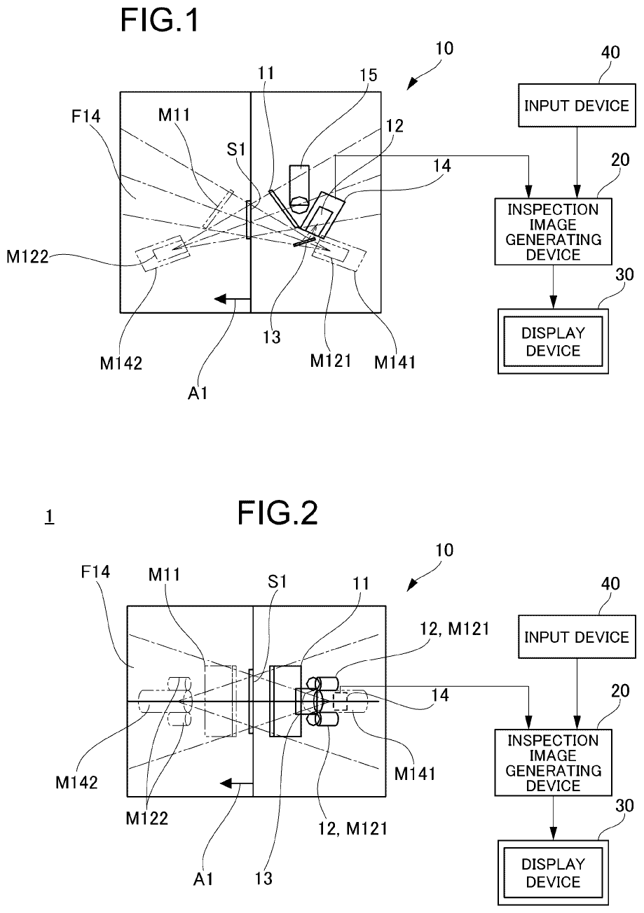

FIGS. 1 and 2 illustrate the configuration of an inspection apparatus 1 according to this embodiment from a first view and a second view, respectively. FIG. 1 is a side view of this configuration, and FIG. 2 is a top view, i.e., when the configuration in FIG. 1 is viewed from above. Assuming the surface of an object being inspected is called an inspection surface S1, the inspection apparatus 1 shown in these drawings is used to inspect the condition of this inspection surface S1. The inspection surface S1 is a metal surface such as that of a reactor pressure vessel. In this case, the inspection apparatus 1 is used to inspect the inspection surface S1 to determine whether cracks have developed therein.

This type of inspection apparatus 1 has various members including an imaging device 10, an inspection image generating device 20, a display device 30, and an input device 40. These components will be described below in the order of the imaging device 10, inspection image generating device 20, display device 30, and input device 40.

### <Imaging Device 10>

The imaging device 10 captures images of the inspection surface S1 using two types of illumination. This type of imaging device 10 has bright-field illumination 11, dark-field illumination 12, a reflection mirror 13, a camera 14, and a holding case 15 (shown only in FIG. 1).

Of these components, the bright-field illumination 11 and dark-field illumination 12 serve to illuminate the inspection surface S1. The bright-field illumination 11 is an illuminator that irradiates light to reflect off the inspection surface S1 and be incident on the camera 14. The bright-field illumination 11 is a surface-emitting panel configured as surface-emitting illumination. The dark-field illumination 12 is also an illuminator that irradiates light to be diffused by the inspection surface S1 and become incident on the camera 14. The dark-field illumination 12 includes two illuminators arranged symmetrically about an optical axis. Note that the bright-field illumination 11 is “surface-emitting illumination” when emphasizing its illumination function, and a “surface-emitting panel” when emphasizing its designation as an illumination device. Moreover, when the dark-field illumination 12 is referred to as diffused illumination, the bright-field illumination 11 is referred to as “reflective illumination” for naming symmetry. However, these components are referred to as bright-field illumination 11 and dark-field illumination 12 in the following description.

Additionally, the dark-field illumination 12 and bright-field illumination 11 may each have adjustable illumination wavelengths.

The reflection mirror 13 reflects light emitted from the bright-field illumination 11 and the dark-field illumination 12 onto the inspection surface S1 and reflects light reflected by the inspection surface S1 toward the camera 14. The camera 14 captures an image of the inspection surface S1 reflected by the reflection mirror 13. Here, the field of view of the camera 14 is generally different vertically and horizontally. In this case, a field of view F14 in the top view of FIG. 2 is wider than the field of view F14 in the side view of FIG. 1. Accordingly, the bright-field illumination 11, which is configured as a surface-emitting panel, is also assumed to have a longer vertical width illustrated in the top view of FIG. 2 than the vertical width illustrated in the side view of FIG. 1, giving the panel a rectangular shape.

In addition, the holding case 15 is a member that integrates the camera 14 and the bright-field illumination 11 using the reflection mirror 13 to achieve a compact layout for the imaging device 10.

Next, a detailed configuration of the imaging device 10 will be described. For convenience in explaining the function of the illumination arranged to improve the visibility of cracks in the inspection surface S1, FIGS. 1 and 2 illustrate a mirror image of the camera 14 produced by the reflection mirror 13 (hereinafter referred to as a camera mirror image M141). FIGS. 1 and 2 also illustrate a mirror image space A1, depicted to the left of the inspection surface S1 in the drawings, which is produced by the inspection surface S1 when assuming the inspection surface S1 is a plane mirror.

Specifically, the mirror images generated in the imaging device 10 are as follows: a camera mirror image M142, which is a further mirror image of the camera mirror image M141; a mirror image M11 of the bright-field illumination 11; a mirror image M121 of the dark-field illumination 12 produced by the reflection mirror 13; and a mirror image M122 of the dark-field illumination 12 produced by the inspection surface S1. Note that the mirror images M121 and M122 of the dark-field illumination 12 each correspond to the two illuminators of the dark-field illumination 12.

In this imaging device 10, the bright-field illumination 11 is arranged such that the mirror image M11 of the bright-field illumination 11, for which the inspection surface S1 is regarded as a virtual mirror surface, covers the field of view F14 of the camera 14. On the other hand, the dark-field illumination 12 is arranged such that the mirror image M121 of the dark-field illumination 12, with the inspection surface S1 regarded as a virtual mirror surface, lies outside the field of view F14 of the camera 14. Consequently, of the light emitted by the bright-field illumination 11 in this imaging device 10, the camera 14 can receive all light directly reflected by the inspection surface S1. Conversely, of the light emitted by the dark-field illumination 12, light directly reflected by the inspection surface S1 does not enter the camera 14, and the camera 14 can receive only light diffusely reflected by the inspection surface S1.

However, not all light emitted from the bright-field illumination 11 becomes direct reflection light; in some cases, light from positions where reflected light would normally not enter the camera 14 may enter the camera 14 after being diffused by the inspection surface S1. Hence, if the inspection surface S1 is a perfectly diffusing surface, for example, the bright-field illumination 11 becomes substantially equivalent to diffusive illumination, with no meaningful distinction from the dark-field illumination 12. However, when the inspection surface S1 is a metal surface, such as that of a reactor pressure vessel, there are often at least partially reflective regions. Since the amount of reflected light produced by the bright-field illumination 11 becomes dominant over the amount of diffusively reflected light in such reflective regions, the bright-field illumination 11 fulfills a function distinct from that of the dark-field illumination 12.

When an inspection surface S1 having an intricate mixture of diffusive regions and reflective regions is illuminated with these two types of illumination, the following occurs. Under the dark-field illumination 12, light is diffused in the diffusive regions and received by the camera 14, while light is reflected in the reflective regions and not received by the camera 14. This results in an image in which the diffusive regions appear bright and the reflective regions appear dark. Under the bright-field illumination 11, on the other hand, some of the light diffused in the diffusive regions is not received by the camera 14, resulting in a relative reduction in light intensity, whereas light reflected in the reflective regions is received brightly by the camera 14. This results in an image in which the diffusive regions appear dark and the reflective regions appear bright.

Since the brightness and darkness in images captured by the camera 14 are inverted between the bright-field illumination 11 and dark-field illumination 12 as described above, the same brightness can be achieved in both diffusive regions and reflective regions at least locally by adjusting the balance of the luminance of the respective illuminations. As a result, the distinction between these regions is lost, and surface texture can no longer be visually recognized in the image.

Now, when cracks are present in the inspection surface S1, the openings of the cracks form fine, valley-like structures. Light incident on these openings is presumed to attenuate while being reflected between the nearly parallel sidewalls of the valley. For this reason, the cracked portions are expected to appear dark, regardless of whether the portions are illuminated by light from the dark-field illumination 12 or the bright-field illumination 11. Thus, under conditions in which the textures of diffusive regions and reflective regions cannot be discerned visually, only cracks become visible, thereby facilitating the determination of cracks. The illumination method described above is referred to as balanced illumination.

When a wide area of the inspection surface S1 is illuminated under the balanced illumination described above, there may be locations in which the luminance at the diffusive regions and reflective regions is balanced and locations in which the luminance is not balanced if the luminance of the bright-field illumination 11 and dark-field illumination 12 is not uniform. Similarly, if the microstructures or coating conditions of the surface vary according to location, the luminance conditions necessary for balance may not be uniform. Accordingly, the inspection apparatus 1 of the present embodiment has the inspection image generating device 20 described below to optimize this balance.

### <Inspection Image Generating Device 20>

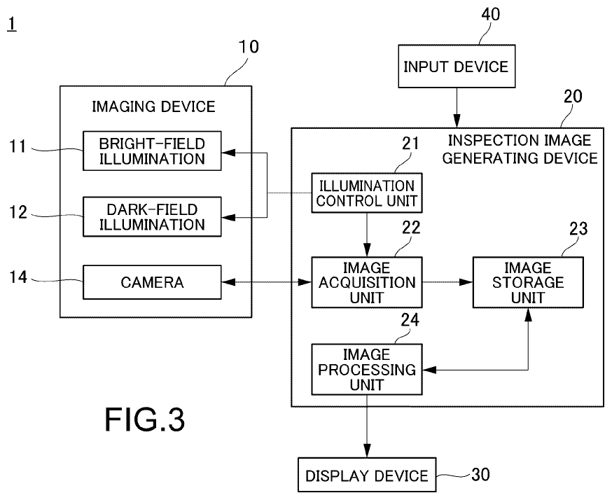

FIG. 3 is a block diagram of the inspection apparatus 1 according to the present embodiment for explaining the configuration of the inspection image generating device 20. The inspection image generating device 20 shown in FIG. 3 is configured of a computer. This computer is configured of hardware used in a typical computing system and includes a network interface capable of exchanging information with the imaging device 10 either via a cable or wirelessly. The inspection image generating device 20 includes an illumination control unit 21, an image acquisition unit 22, an image storage unit 23, and an image processing unit 24 as functional units that execute respective functions in accordance with a program stored in the computer. These units are described next.

### [Illumination Control Unit 21]

The illumination control unit 21 turns on and off the bright-field illumination 11 and dark-field illumination 12 in the imaging device 10. For example, when receiving an instruction to start inspection from the input device 40, the illumination control unit 21 sequentially turns on and off the bright-field illumination 11 and the dark-field illumination 12 according to a predetermined procedure. The illumination intensity when turning on the bright-field illumination 11 and dark-field illumination 12 is preset and can be changed in response to instructions from the input device 40. Further, if the bright-field illumination 11 and dark-field illumination 12 have freely adjustable illumination wavelengths, their respective illumination wavelengths are preset according to the condition of the inspection surface S1. The timings at which the illumination control unit 21 turns on and off the bright-field illumination 11 and dark-field illumination 12 will be described later in detail in the inspection method.

### [Image Acquisition Unit 22]

The image acquisition unit 22 drives the camera 14 of the imaging device 10 in coordination with the illumination control unit 21 and acquires images captured by the camera 14. The image acquisition unit 22 sequentially acquires a plurality of images by controlling the camera 14 to capture images of the inspection surface S1 in synchronization with the turning on of the bright-field illumination 11 and dark-field illumination 12. Images acquired by the image acquisition unit 22 include a bright-field image captured when only the bright-field illumination 11 is turned on, and a dark-field image captured when only the dark-field illumination 12 is turned on. The timings at which the image acquisition unit 22 acquires images will be described later in detail in the inspection method.

### [Image Storage Unit 23]

The image storage unit 23 stores the bright-field image and dark-field image acquired by the image acquisition unit 22 separately.

### [Image Processing Unit 24]

The image processing unit 24 generates an inspection image using the bright-field image and dark-field image stored in the image storage unit 23. For the inspection image, the image processing unit 24 generates a balanced image that minimizes the standard deviation of the combined luminance of corresponding pixels between the bright-field image and dark-field image within a calculation range preset in the image area. The image processing procedure performed by the image processing unit 24 to generate an inspection image (a balanced image) will be described later in detail in the inspection method. Note that the preset calculation range may be arbitrarily set range set in advance.

### <Display Device 30>

The display device 30 displays the inspection image (balanced image) generated by the image processing unit 24 of the inspection image generating device 20.

### <Input Device 40>

The input device 40 inputs instructions to start inspection and various settings in the inspection image generating device 20. The settings inputted from the input device 40 are the above-described calculation range, the luminances of the bright-field illumination 11 and the dark-field illumination 12, and the like. This input device 40 may be replaced by an external device such as a personal computer connected to the inspection image generating device 20.

### <<Inspection Method>>

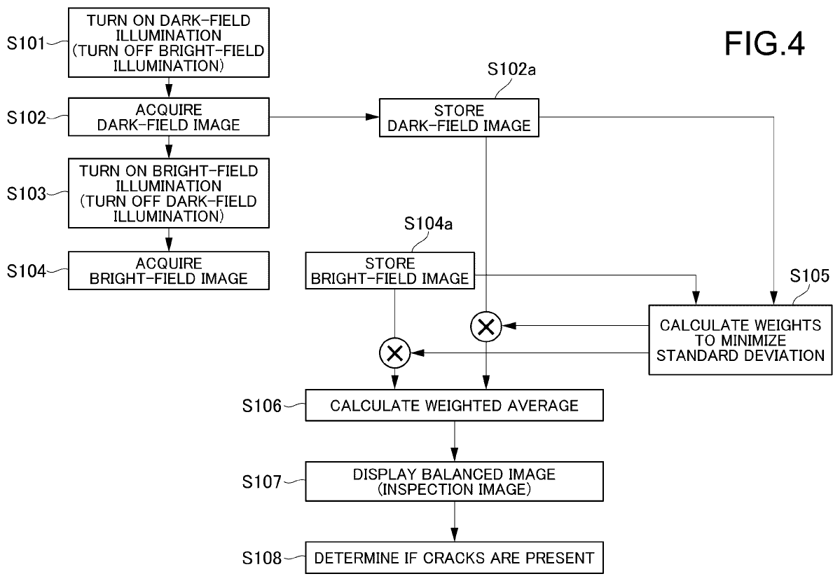

FIG. 4 is a flowchart explaining the inspection method according to the present embodiment. The inspection method shown in this flowchart is performed in accordance with a program residing on the inspection image generating device 20 of the inspection apparatus 1 described with reference to FIG. 3. Below, the inspection method following the flowchart in FIG. 4 for detecting the presence of cracks in the inspection surface S1 will be described while referring to the previous FIGS. 1 to 3 and other necessary drawings.

### <Image Acquisition Steps>

### [Step S101]

In Step S101, the illumination control unit 21 turns on the dark-field illumination 12 while keeping the bright-field illumination 11 turned off.

### [Step S102]

In Step S102, the image acquisition unit 22 drives the camera 14 to acquire a dark-field image of the inspection surface S1.

### [Step S102a]

In Step S102a, the dark-field image acquired by the image acquisition unit 22 is stored in the image storage unit 23.

### [Step S103]

In Step S103, the illumination control unit 21 turns off the dark-field illumination 12 and turns on the bright-field illumination 11.

### [Step S104]

In Step S104, the image acquisition unit 22 drives the camera 14 to acquire a bright-field image of the inspection surface S1.

### [Step S104a]

In Step S104a, the bright-field image acquired by the image acquisition unit 22 is stored in the image storage unit 23.

Note that the procedure of acquiring and storing the dark-field image and the procedure of acquiring and storing the bright-field image may be performed in reverse in the above image acquisition steps.

### <Image Process Steps>

### [Step S105]

In Step S105, the image processing unit 24 performs weighting calculations to minimize the standard deviation of luminance for each pixel in the dark-field image and bright-field image stored in the image storage unit 23. At this time, the image processing unit 24 individually calculates an optimal gain value that minimizes the standard deviation of luminance within the calculation range set in the image area for each corresponding pixel of the dark-field image and the bright-field image.

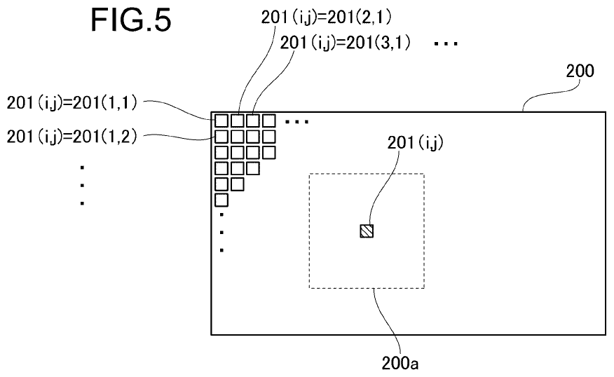

FIG. 5 illustrates the image process in the inspection method according to the embodiment for explaining the process to calculate optimal gain values performed by the image processing unit 24 shown in FIG. 3. As shown in FIG. 5, an image area 200 of the dark-field image and the bright-field image is composed of a plurality of pixels 201(i, j) arranged in a matrix. The image processing unit 24 calculates the optimal gain value for each pixel 201(i, j) located in the center of a predetermined calculation range 200a.

This calculation range 200a is a range arbitrarily set in advance based on input from the input device 40. The calculation range 200a may be a range of 50×50 pixels having a pixel count N of 2,500, for example, or may be set to a size that accounts for an area in which the condition of the inspection surface S1 changes. Alternatively, the calculation range 200a may be the entire image area 200 or an entire inspection area (not shown) set within the image area 200.

Here, the optimal gain value can be found analytically as follows. Let [A(i, j)] be the luminance of the dark-field image at pixel 201(i, j), [B(i, j)] be the luminance of the bright-field image at pixel 201(i, j), [a] be the optimal gain value for the dark-field image, and [1-a] be the optimal gain value for the bright-field image. In this case, a combined luminance [C(i, j)] of pixel 201(i, j) in the weighted-average composite image (i.e., the inspection image, which is the balanced image) is expressed by the following Equation (1). Note that the optimal gain value [a] and the optimal gain value [1−a] are the optimal gain value [a](i, j) and the optimal gain value [1−a](i, j) for each pixel 201(i, j). The same applies hereafter.

$$[ Equation 1 ]$$

$$C ( i , j ) = aA ( i , j ) + ( 1 - a ) B ( i , j ) \qquad Equation ( 1 )$$

A variance S of the combined luminance [C(i, j)] is expressed as the square of the standard deviation σ in the following Equation (2). Note that the pixel count N in the calculation range 200a is not constant for all pixels 201 (i, j) and is a smaller value along the edges of the image area 200.

$$[ Equation 2 ]$$

$$S = {σ}^{2} = \overline{{( C - \overline{C} )}^{2}} = \overline{{C}^{2} - 2 C \overline{C} + {\overline{C}}^{2}} = \overline{{C}^{2}} - {\overline{C}}^{2} = \frac{1}{N} \sum {\{ C ( i , j ) \}}^{2} - {\{ \frac{1}{N} \sum C ( i , j ) \}}^{2} \qquad Equation ( 2 )$$

Equation (3) is obtained by differentiating Equation (2) with respect to the optimal gain value [a].

$$[ Equation 3 ]$$

$$\frac{\partial S}{\partial a} = \frac{2}{N} \sum C ( i , j ) \frac{\partial C}{\partial a} - 2 \{ \frac{1}{N} \sum C ( i , j ) \} \{ \frac{1}{N} \sum \frac{\partial C}{\partial a} \} = \frac{2}{N} \sum \{ aA + ( 1 - a ) B \} \{ A - B \} - \frac{2}{{N}^{2}} \{ \sum \{ aA + ( 1 - a ) B \} \} \text{} \{ \sum \{ A - B \} \} = \frac{2}{N} \sum \{ {a ( A - B )}^{2} + B ( A - B ) \} - \frac{2}{{N}^{2}} \{ \sum \{ a ( A - B ) \} + \sum \{ B \} \} \text{} \{ \sum \{ A - B \} \} = a \{ \frac{2}{N} \sum \{ {( A - B )}^{2} \} - \frac{2}{{N}^{2}} {\{ \sum \{ A - B \} \}}^{2} \} + \frac{2}{N} \{ \sum \{ B ( A - B ) \} \} - \frac{2}{{N}^{2}} \{ \sum \{ B \} \} \{ \sum \{ A + B \} \} = 0 \qquad Equation ( 3 )$$

The above Equation (3) is then rearranged to calculate the optimal gain value [a] for each pixel 201(i, j), as shown in the following Equation (4).

$$[ Equation 4 ]$$

$$a = \frac{\{ \sum \{ B \} \} \{ \sum \{ A - B \} \} - N \{ \sum \{ B ( A - B ) \} \}}{N \sum \{ {( A - B )}^{2} \} - {\{ \sum \{ A - B \} \}}^{2}} \qquad Equation ( 4 )$$

### [Step S106]

In Step S106, the image processing unit 24 performs a process to calculate the weighted average on the luminance of each pixel 201(i, j) in the dark-field image and the bright-field image stored in the image storage unit 23 based on the optimal gain value [a] for each pixel 201(i, j) calculated in Step S105. Here, the combined luminance [C(i, j)] is calculated from the luminance A(i, j) in the dark-field image, the luminance B(i, j) in the bright-field image, and the calculated optimal gain value [a] for each pixel 201(i, j), as shown above in Equation (1). These calculations produce the inspection image (balanced image).

### <Inspection Steps>

### [Step S107]

In Step S107, the inspection image (balanced image) synthesized by the weighted average process of Step S106 is displayed on the display device 30.

### [Step S108]

In Step S108, an inspector visually inspects the inspection image (balanced image) displayed on the display device 30 to determine the presence of any cracks, which would be displayed in black in the inspection image (balanced image), for example. Note that determining the presence of cracks is not limited to a visual determination by an inspector but may be performed through image processing. In this case, the inspection apparatus 1 need not possess the display device 30.

If the inspection surface S1 is wider than the imaging range of the camera 14, the imaging device 10 may be moved relative to the inspection surface S1, and the procedure described above may be repeated for each position of the imaging device 10.

### Effects of Embodiment

According to the embodiment described above, an inspection image (balanced image) that minimizes the standard deviation of luminance in an image area is obtained by combining a dark-field image of the inspection surface S1 obtained under dark-field illumination with a bright-field image of the inspection surface S1 obtained under bright-field illumination. If a crack has developed in the inspection surface S1, the cracked portion in this inspection image (balanced image) is likely to appear clearly within the image area where luminance has been made uniform. This is because the reflection of illuminated light is extremely weak at cracks, due to their being shaped as deep cuts with narrow openings. Hence, the visibility of cracks can be improved even under conditions in which the surface textures in diffusive regions and reflective regions are not visible.

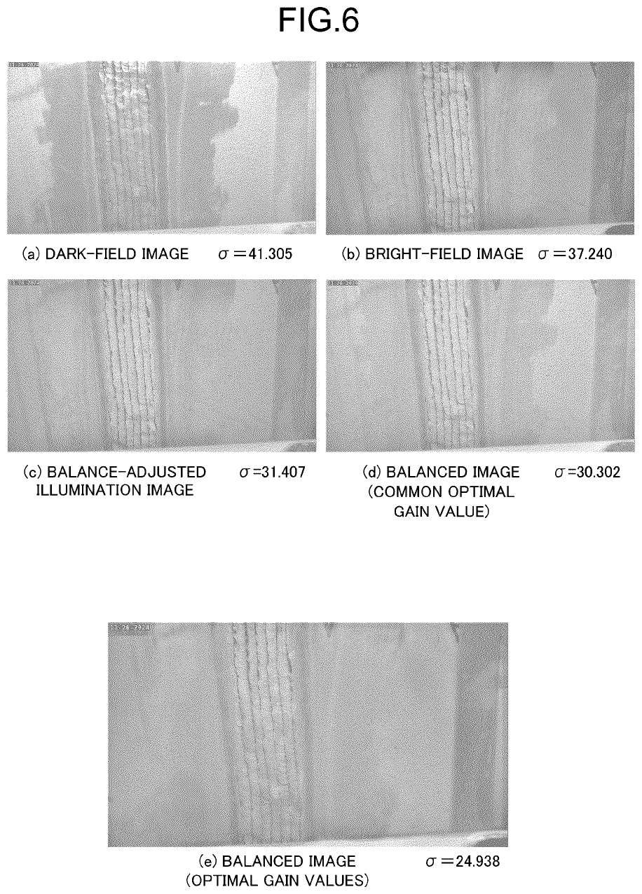

FIG. 6 illustrates each image of the inspection surface S1 captured by the imaging device 10, and composite images formed by combining those images. The inspection surface S1 has a weld bead area.
(a) A dark-field image is an image obtained by turning only the dark-field illumination 12 on.
(b) A bright-field image is an image obtained by turning only the bright-field illumination 11 on.
(c) A balance-adjusted illumination image is an image obtained by adjusting the bright-field illumination and the dark-field illumination and emitting them simultaneously.
(d) A balanced image is an image obtained by combining the dark-field image and the bright-field image using an optimal gain value calculated in common for all pixels.
(e) A balanced image is an image obtained by combining the dark-field image and the bright-field image using an optimal gain value calculated for each pixel within a 50×50-pixel calculation range.

The images are Full HD having 1920×1080 pixels, with 8 bits for each RGB component. The standard deviation value of luminance for the entire image is indicated in the lower right of each image. Peripheral areas on the left and right of the (a) dark-field image are bright, while the area around the central bead is bright in the (b) bright-field image. This reveals that the inspection surface S1 is diffusive in the left and right peripheral areas and reflective around the central bead. In the (c) balance-adjusted illumination image, it can be seen that luminance has been balanced primarily to reduce the contrast around the boundary between the diffusive region and reflective region on the right side, which is easy to discern, but the standard deviation has been decreased across the entirety of the (d) balanced image and the (e) balanced image.

As is clear from FIG. 6, the (d) and (e) balanced images synthesized from the dark-field image and bright-field image using optimal gain values have a small standard deviation of luminance in the image area. Consequently, any differences in texture in the inspection surface have become difficult to perceive. Therefore, when a crack has formed in the inspection surface, only the luminance of pixels corresponding to the crack appears particularly dark, making the presence of cracks easier to determine. In the (e) balanced image, in particular, which was synthesized by setting the calculation range to 50×50 pixels, the standard deviation of luminance in the image area has dropped to [σ]=24.9. This indicates that the contrast of texture resulting from the distribution of reflective and diffusive regions has been significantly suppressed. Consequently, the presence of cracks becomes even easier to detect.

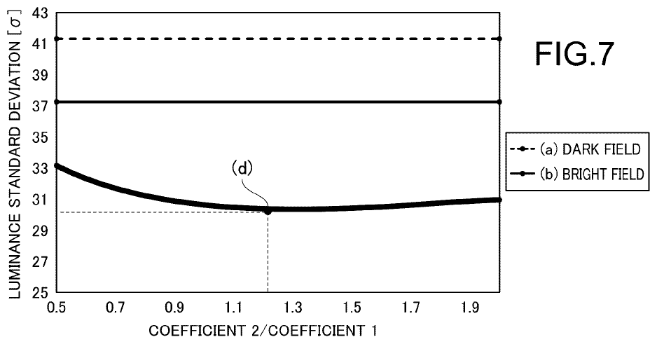

FIG. 7 illustrates the standard deviation of luminance for each image by plotting the luminance standard deviation [σ] of the inspection image (balanced image) relative to the ratio of the gain values (coefficient 2/coefficient 1). The ratio of gain values (coefficient 2/coefficient 1) is found by the gain value for the bright-field image (coefficient 1) and the gain value for the dark-field image (coefficient 2) and is common to all pixels. For comparison, the luminance standard deviation [σ] of the (a) dark-field image in FIG. 6 (=41.305) and the luminance standard deviation [σ] of the (b) bright-field image in FIG. 6 (=37.240) are also depicted in the graph.

This graph illustrates that the luminance standard deviation [σ] can be reduced over the entire image area by combining the bright-field and dark-field images. It is also clear that the luminance standard deviation [σ] can be minimized by adjusting the ratio of the gain values to be multiplied with the original luminance when combining the bright-field image and the dark-field image. The minimum value of the luminance standard deviation [σ] in the graph corresponds to the (d) balanced image in FIG. 6.

According to the embodiment described above, an inspection image (balanced image) that facilitates the determination of the presence of cracks can be obtained as described above by performing image processing only on a bright-field image and a dark-field image acquired one at a time. Therefore, compared to the technique described in Patent Literature 1 in which it is necessary to repeatedly control the luminance of each of the bright-field illumination and the dark-field illumination independently of each other until the difference in brightness between the (diffusive) regions and the (reflective) regions within the image area becomes small, the effort needed to obtain an optimal inspection image can be reduced.

The present invention is not limited to the above-described embodiment and variations thereof but encompasses various other modifications. For example, the above embodiment has been described in detail to facilitate understanding of the present invention and is not limited to having all the described configurations. Further, some of the configurations of one embodiment can be replaced with configurations of another embodiment, and the configurations of other embodiments can be added to the configurations of the one embodiment.

Moreover, other configurations may be added to each embodiment and some configurations in each embodiment may be deleted or replaced with other configurations.

What is claimed is:

1. An inspection apparatus comprising:
a plurality of types of illumination that illuminate an inspection surface;
a camera that captures images of the inspection surface; and
an image processing unit that generates an inspection image by combining a plurality of images of the inspection surface sequentially captured by the camera as the plurality of types of illumination are sequentially turned on, wherein the image processing unit generates the inspection image so as to minimize the standard deviation of the combined luminance of each corresponding pixel among the plurality of images within a predetermined calculation range set in an image area of the images.

2. The inspection apparatus according to claim 1, wherein the plurality of types of illumination are dark-field illumination and bright-field illumination.

3. The inspection apparatus according to claim 2, wherein the dark-field illumination is arranged at a plurality of locations.

4. The inspection apparatus according to claim 1, wherein the calculation range is an arbitrarily set range.

5. The inspection apparatus according to claim 1, wherein the image processing unit calculates, for each of the pixels, an optimal gain value of a luminance that minimizes a standard deviation of the luminance of a plurality of pixels constituting the calculation range around each of the pixels, and generates the inspection image by applying weighted averaging to a luminance of the pixel using the calculated optimal gain value.

6. The inspection apparatus according to claim 1, further comprising:
an illumination control unit that sequentially turns on the plurality of types of illumination; and
an image acquisition unit that sequentially acquires the plurality of images of the inspection surface by controlling the camera to capture the images in synchronization with the turning on of the plurality of types of illumination, wherein
the image processing unit generates the inspection image using each image sequentially acquired by the image acquisition unit.

7. The inspection apparatus according to claim 1, further comprising a display device that displays the inspection image.

8. An inspection method comprising:
a step of illuminating an inspection surface by sequentially turning on a plurality of types of illumination; and
a step of sequentially capturing images of the inspection surface with a camera in synchronization with the turning on of the plurality of types of illumination, wherein
an image processing unit generates an inspection image so as to minimize a standard deviation of the combined luminance of each corresponding pixel among the plurality of images captured by the camera within a predetermined calculation range set in an image area of the images.
